(19) United States
(12) Patent Application Publication
(10) Pub. No.: US 2012/0287105 A1
(43) Pub. Date: Nov. 15, 2012

(54) METHOD FOR DRIVING PLASMA DISPLAY PANEL AND PLASMA DISPLAY DEVICE

(76) Inventors: Kazuhiro Kanai, Chiba (JP); Hidehiko Shoji, Osaka (JP); Naoyuki Tomioka, Osaka (JP); Takahiko Origuchi, Osaka (JP)

(21) Appl. No.: 13/522,674

(22) PCT Filed: Jan. 19, 2011
(86) PCT No.: PCT/JP2011/000241

§ 371 Date: Jul. 17, 2012

(30) Foreign Application Priority Data
Jan. 19, 2010 (JP) 2010008775

(51) Int. Cl. G09G 5/00; G09G 3/28

(52) U.S. Cl. 345/211; 345/60

(57) ABSTRACT

The present invention provides a method of driving a plasma display apparatus, which allows a high-luminance large-sized panel to have stable address discharge, with increase in power consumption suppressed. In the method, one field is divided into a plurality of subfields, each of which having an address period and a sustain period. A ramp voltage is applied to the scan electrodes in the end of the sustain period. The ramp voltage increases from a base potential toward a predetermined voltage, after reaching the predetermined voltage, the ramp voltage is maintained at the voltage for a predetermined period of time and decreases to the base potential. Besides, when the number of the sustain pulses is not greater than a predetermined threshold in a subfield, the predetermined period of time of an immediately after subfield is determined to be longer than the predetermined period of time of other subfields.

### TECHNICAL FIELD

The present invention relates to a method of driving a plasma display panel used for wall-hanging TVs or large monitors and also relates to a plasma display apparatus driven by the method.

### BACKGROUND ART

An AC surface discharge panel, i.e. a typical plasma display panel (hereinafter, simply referred to as a “panel”), has a plurality of discharge cells between a front substrate and a rear substrate oppositely disposed to each other. On a glass substrate of the front substrate, a plurality of display electrode pairs, each including a scan electrode and a sustain electrode, is arranged in parallel with each other. A dielectric layer and a protective layer are formed over the display electrode pairs.

On a glass substrate of the rear substrate, a plurality of data electrodes is arranged in parallel with each other, and over which, a dielectric layer is formed so as to cover them. On the dielectric layer, a plurality of barrier ribs is formed so as to be parallel with the data electrodes. A phosphor layer is formed on the surface of the dielectric layer and on the side surface of the barrier ribs.

The front substrate and the rear substrate are oppositely located in a manner that the display electrode pairs are positioned orthogonal to the data electrodes, and the two substrates are sealed with each other via discharge space therebetween. The discharge space is filled with a discharge gas, for example, containing xenon at a partial pressure of 5%. Discharge cells are formed at intersections of the display electrode pairs and the data electrodes. In the panel with the structure above, ultraviolet rays are generated by gas discharge in each discharge cell. The ultraviolet rays excite phosphors of the red (R) color, green (G) color, and blue (B) color so that light is emitted for the display of a color image.

A typically used driving method of the panel is a subfield method. In the subfield method, gradations are displayed by dividing one field period into a plurality of subfields and causing light emission or no light emission in each discharge cell in each subfield. Each of the subfields has an initializing period, an address period, and a sustain period.

In the initializing period, a voltage with an initializing waveform is applied to each scan electrode to generate an initializing discharge in each discharge cell. The initializing discharge forms wall charge necessary for the subsequent address operation, and generates priming particles (i.e., excited particles for generating a discharge) for providing an address discharge with stability.

In the address period, scan pulses are sequentially applied to the scan electrodes, at the same time, address pulses are selectively applied to the data electrodes according to an image signal to be displayed. The application of voltage generates an address discharge between a scan electrode and a data electrode at a discharge cell to have light emission, and forms wall charge in the discharge cell (hereinafter, the address operation is also referred collectively as “addressing”).

In the sustain period, sustain pulses in number predetermined for each subfield are applied alternately to the scan electrodes and the sustain electrodes of the display electrode pairs. The application of the pulses generates a sustain discharge in the discharge cells having undergone the address discharge and causes the phosphor layers to emit light in the discharge cells, by which each discharge cell emits light at a luminance corresponding to a luminance weight determined for each subfield. (Hereinafter, light emission of a discharge cell caused by a sustain discharge may be represented by “light-on” and no light emission of a discharge cell may be represented by “light-off”). Thus, each discharge cell of the panel emits light at a luminance corresponding to the gradation values of image signals, displaying an image in the image display area of the panel.

To drive the panel, the plasma display apparatus has a scan electrode driver circuit, a sustain electrode driver circuit, and a data electrode driver circuit. Each of the driver circuit applies a driving voltage waveform to each electrode to display an image on the panel.

Recent trend of a high-definition panel with a large screen increases power consumption of a plasma display apparatus. The data electrode driver circuit applies address pulses corresponding to the image signal to each data electrode so as to generate address discharge in the discharge cells. If the power consumption in the data electrode driver circuit exceeds a permissible value (maximum rating) of the circuit elements forming the data electrode driver circuit, the quality of display image can be ruined due to failure of normal address operation by malfunction of the driver circuit. Employing a circuit element with an increased permissible value can avoid the problem above; but such a circuit element is expensive, increasing the production cost of the plasma display apparatus.

To address above, for example, patent literature 1 introduces a method of suppressing power consumption of the data electrode driver circuit without degradation of image display quality. According to the method, changing the application order of address pulses to the data electrodes reduces charge/discharge current that flows in charging/discharging of the data electrodes, thereby suppressing power consumption of the data electrode driver circuit.

As another method, for example, patent literature 2 introduces a technique to control the number of sustain pulses in the sustain period. According to the method, changing the number of sustain pulses in each subfield controls the number of light emission in the sustain period. For example, one field period is formed of eight subfields having the first subfield, the second subfield, . . . , the eighth subfield (hereinafter, the first subfield is referred to SF1 and the second subfield is referred to SF2). In the structure, for example, the number of sustain pulses applied to SF1 through SF8 is determined as follows: 1, 2, 4, 8, 16, 32, 64, and 128. When the number of sustain pulses for each subfield is doubled, SF1 through SF8 has the following number of sustain pulses: 2, 4, 8, 16, 32, 128, and 256. Further, the originally set number of sustain pulses for each subfield is changed so as to have threefold increase or fourfold increase (hereinafter, the magnification ratio is referred to luminance magnification). In this way, changing luminance magnification controls the number of light emission in the sustain period. Specifically, increase in luminance magnification provides a dark image with brightness, whereas decrease in luminance magnification saves power consumption.

A high-definition large-sized panel has increase in number of the electrodes to be driven, and also has increase in impedance of the apparatus in operation, thereby increasing power consumption. Therefore, further decrease in power consumption is needed for the plasma display apparatus having the aforementioned panel. However, decrease in driving voltage to be applied to the discharge cells for reducing power consumption can lose stability in a discharge generated in the discharge cells.

As the level of high-definition increases, the discharge cells have to be microscopic. In such a minute structure, the wall charge formed in a discharge cell by initializing discharge is susceptible to address discharge generated in the neighboring cells. For example, the wall charge in a discharge cell having no address discharge decreases under the influence of address discharge of the neighboring cells (hereinafter, the phenomenon is referred to escape of electric charge). A significant decrease in wall charge due to the escape of electric charge in the discharge cell causes no address discharge in a discharge cell where it is expected (hereinafter, the phenomenon is also referred to non-lighting). Such a discharge failure can deteriorate image display quality.

Stable generation of an address discharge is attained by increase in amplitude of the address pulses so as to increase voltage to be applied to the discharge cells. However, increase in amplitude of the address pulses inconveniently increases power consumption. Further, excessive increase of the amplitude can cause another problem—an address discharge is generated in a discharge cell where it is not expected.

### CITATION LIST

### Patent Literature

PTL 1

Japanese Patent Unexamined Publication No. H11-282398

PTL 2

Japanese Patent Unexamined Publication No. H8-286636

### SUMMARY OF THE INVENTION

The present invention provides a method of driving a panel, the panel having a plurality of discharge cells arranged therein, each of the discharge cells having a data electrode and a display electrode pair of a scan electrode and a sustain electrode. In the method, one field period is formed of a plurality of subfields, each of the subfields has an address period, and a sustain period where sustain pulses corresponding in number to luminance weight are applied to the display electrode pairs. In the method, at the end of the sustain period, an up-ramp waveform voltage is applied to the scan electrodes. The up-ramp waveform voltage has a waveform that changes as follows: it rises from the base potential toward a predetermined voltage; after reaching the predetermined voltage, it is kept at the voltage level for a predetermined period of time; and it goes down to the base potential. At the same time, if a subfield has the number of sustain pulses not greater than a predetermined threshold, the aforementioned predetermined period of time of the next subfield is determined to be longer than those of other subfields.

The method allows a high-definition large-sized panel to have saved power consumption, generating an address discharge with stability.

In the method of the present invention, the aforementioned advantage can be attained by the following application of voltage. That is, after generation of the sustain pulses in the sustain period, a down-ramp waveform voltage, which goes down to a negative voltage exceeding a discharge start voltage, is applied to the scan electrodes, and after that, an up-ramp waveform voltage is applied to the scan electrodes.

The plasma display apparatus of the present invention includes the following elements:
a panel having a plurality of discharge cells arranged therein, each of the discharge cells having a data electrode and a display electrode pair of a scan electrode and a sustain electrode; and
a driver circuit for driving the panel.

The driver circuit forms one field period of a plurality of subfields, each of the subfields has an address period, and a sustain period where sustain pulses corresponding in number to luminance weight are applied to the display electrode pairs. The driver circuit applies an up-ramp waveform voltage to the scan electrodes at the end of the sustain period. The up-ramp waveform voltage has a waveform that changes as follows: it rises from the base potential toward a predetermined voltage; after reaching the predetermined voltage, it is kept at the voltage level for a predetermined period of time; and it goes down to the base potential. At the same time, the driver circuit determined the aforementioned predetermined period of time as follows: if a subfield has the number of sustain pulses not greater than a predetermined threshold, the aforementioned predetermined period of time of the next subfield is determined to be longer than those of other subfields.

The structure allows a high-definition large-sized panel to have saved power consumption, generating an address discharge with stability.

In the plasma display apparatus of the present invention, the aforementioned advantage can be attained by the following application of voltage. That is, after generating the sustain pulses in the sustain period, the driver circuit applies a down-ramp waveform voltage, which goes down to a negative voltage exceeding a discharge start voltage, to the scan electrodes, and after that, the driver circuit applies an up-ramp waveform voltage to the scan electrodes.

### BRIEF DESCRIPTION OF THE DRAWINGS

FIG. 1 is an exploded perspective view showing the structure of a panel for use in a plasma display apparatus in accordance with an exemplary embodiment of the present invention.

FIG. 2 is an electrode array diagram of the panel for use in the plasma display apparatus in accordance with the exemplary embodiment.

FIG. 3 is a chart of driving voltage waveforms applied to respective electrodes of the panel used for the plasma display apparatus in accordance with the exemplary embodiment.

FIG. 4 schematically shows the discharge cells formed in the panel of the plasma display apparatus in accordance with the exemplary embodiment.

FIG. 5 shows a diagram of a non-lighting pattern occurred in the discharge cells shown in FIG. 4.

FIG. 6 shows a diagram of another non-lighting pattern occurred in the discharge cells shown in FIG. 4.

FIG. 7 is a graph showing the relation between the amplitude of address pulses necessary for generating a stable address discharge in the current subfield and the number of sustain pulses generated in the immediately before subfield in the plasma display apparatus in accordance with the embodiment.

FIG. 8 is a graph showing a relation between the length of a predetermined period of time for erasing up-ramp voltage L3 in the current subfield and the amplitude of address pulses necessary for generating a stable address discharge in the immediately after subfield in the plasma display apparatus in accordance with the exemplary embodiment.

FIG. 9 is another graph showing a relation between the length of a predetermined period of time for erasing up-ramp voltage L3 in the current subfield and the amplitude of address pulses necessary for generating a stable address discharge in the immediately after subfield in the plasma display apparatus in accordance with the exemplary embodiment.

FIG. 10 shows the circuit block diagram of the plasma display apparatus in accordance with the exemplary embodiment.

FIG. 11 is a circuit diagram showing the structure of the scan electrode driver circuit of the plasma display apparatus in accordance with the exemplary embodiment.

FIG. 12 is a timing chart showing an example of the workings of the scan electrode driver circuit in an all-cell initializing period in accordance with the exemplary embodiment.

FIG. 13 shows another waveform of erasing down-ramp voltage L5 to be applied to the scan electrodes in accordance with the exemplary embodiment.

### DESCRIPTION OF EMBODIMENTS

Hereinafter, a plasma display apparatus in accordance with an exemplary embodiment of the present invention is described, with reference to the accompanying drawings.

### Exemplary Embodiment

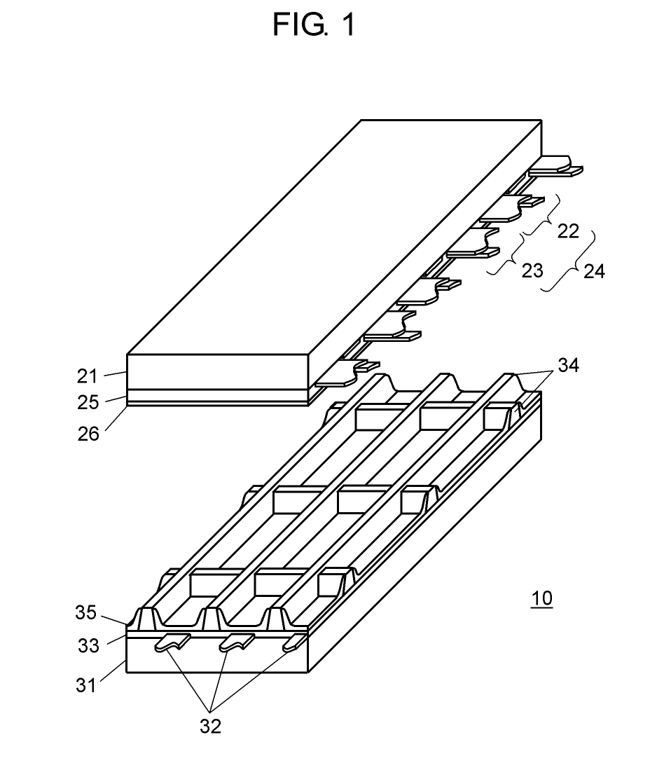

FIG. 1 is an exploded perspective view showing the structure of panel 10 for use in a plasma display apparatus in accordance with the exemplary embodiments of the present invention. A plurality of display electrode pairs, each including scan electrode 22 and sustain electrode 23 is disposed on glass-made front substrate 21. Dielectric layer 25 is formed so as to cover scan electrodes 22 and sustain electrodes 23. Protective layer 26 is formed over dielectric layer 25.

Protective layer 26 is made of a material predominantly composed of magnesium oxide (MgO). The material is proven as being effective in decreasing a discharge start voltage in the discharge cells. Besides, the MgO-based material offers a large coefficient of secondary electron emission and high durability against discharge gas having neon (Ne) and xenon (Xe).

On rear substrate 31, a plurality of data electrodes 32 is disposed. Dielectric layer 33 is formed so as to cover data electrodes 32, and grid-like barrier ribs 34 are formed on the dielectric layer. On the side faces of barrier ribs 34 and on dielectric layer 33, phosphor layers 35 for emitting light of red color (R), green color (G), and blue color (B) are formed.

Front substrate 21 and rear substrate 31 are oppositely disposed to each other such that display electrode pairs 24 are positioned orthogonal to data electrodes 32 with a small discharge space sandwiched between the electrodes. The outer peripheries of the substrates are sealed with a sealing material, such as a glass frit. The inside of the discharge space is filled with discharge gas, for example, a mixed gas of neon and xenon. The discharge gas employed for the embodiment has a xenon partial pressure of approximately 15% so as to improve emission efficiency in the discharge cells.

Barrier ribs 34 divide the discharge space into a plurality of compartments in a way that each compartment has the intersecting part of display electrode pair 24 and data electrode 32. Discharge cells are thus formed at the intersecting parts of display electrode pairs 24 and data electrodes 32. The discharge cells have a discharge and emit light (light on) so as to display a color image on panel 10.

In panel 10, one pixel is formed by three successive discharge cells, a discharge cell for emitting light of red color (R), a discharge cell for emitting light of green color (G), and a discharge cell for emitting light of blue (B) color, arranged in the extending direction of display electrode pair 24. Hereinafter, a discharge cell that emits red light is referred to as an R discharge cell, a discharge cell that emits green light is referred to as a G discharge cell, and a discharge cell that emits blue light is referred to as a B discharge cell.

The structure of panel 10 is not limited to the above, and may include barrier ribs formed into stripes, for example. The mixture ratio of the discharge gas is not limited to the above numerical value, and other mixture ratios may be used. For example, the xenon partial pressure may be increased for enhancing emission efficiency.

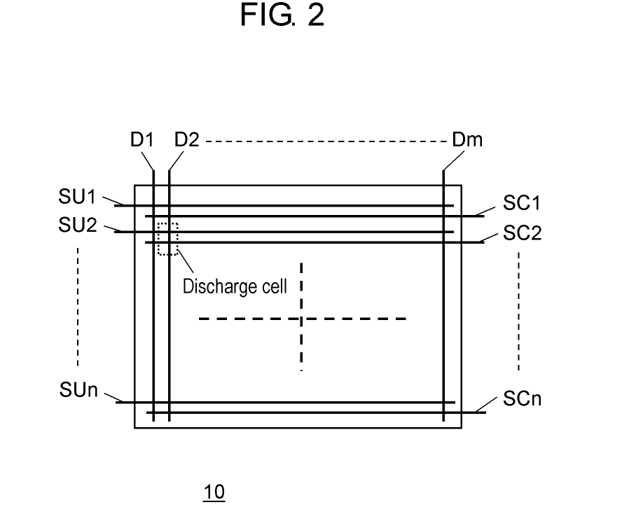

FIG. 2 is an electrode array diagram of panel 10 for use in the plasma display apparatus in accordance with the exemplary embodiment of the present invention. Panel 10 has n scan electrodes SC1 through SCn (that form scan electrodes 22 in FIG. 1) and n sustain electrodes SU1 through SUn (that form sustain electrodes 23 in FIG. 1) both extending in the horizontal (row) direction, and m data electrodes D1 through Dm (that form data electrodes 32 in FIG. 1) extending in the vertical (line) direction. A discharge cell is formed at the part where a pair of scan electrode SCi (i=1 to n) and sustain electrode SUi intersects one data electrode Dj (j=1 to m). That is, m discharge cells (i.e. m/3 pixels) are formed for each display electrode pair 24. In the discharge space, m×n discharge cells are formed. The area having m×n discharge cells is the image display area of panel 10. For example, in a panel having 1920×1080 pixels, m=1920×3 and n=1080. Although n=768 in the embodiment, it is not to be construed as limiting value.

Next, the method of driving panel 10 of the plasma display apparatus of the exemplary embodiment will be described. The plasma display apparatus of the embodiment display gradations by a subfield method. In the subfield method, one field is divided into a plurality of subfields along a temporal axis, and a luminance weight is set for each subfield. Each of the subfields has an initializing period, an address period, and a sustain period. By controlling the light emission and no light emission in each discharge cell in each subfield, an image is displayed on panel 10.

The luminance weight represents a ratio of the magnitudes of luminance displayed in the respective subfields. In the sustain period of each subfield, sustain pulses corresponding in number to the luminance weight are generated. For example, the light emission in the subfield having the luminance weight “8” is approximately eight times as high as that in the subfield having the luminance weight “1”, and approximately four times as high as that in the subfield having the luminance weight “2”. Therefore, the selective light emission caused by the combination of the respective subfields in response to image signals allows the panel to display various gradations forming an image.

In this exemplary embodiment, one field is divided into eight subfields (subfield SF1, subfield SF2, . . . , subfield SF8). The luminance weight is determined in a way that a subfield that follows on a previous subfield in a temporally order has a luminance weight greater than that of the previous subfield. Respective subfields have luminance weights of 1, 2, 4, 8, 16, 32, 64, and 128. With the structure above, each of the R signal, the G signal, and the B signal is displayed in 256 gradation levels from 0 to 255.

In the initializing period of one subfield among a plurality of subfields, an all-cell initializing operation for causing an initializing discharge in all the discharge cells is performed. In the initializing periods of the other subfields, a selective initializing operation for causing an initializing discharge only in the discharge cells having undergone a sustain discharge in the sustain period of the immediately preceding subfield is performed. Hereinafter, the subfield having the all-cell initializing operation is referred to as an all-cell initializing subfield, while the subfield having the selective initializing operation is referred to as a selective initializing subfield.

In the embodiment, the description will be given on a case where subfield SF1 is the all-cell initializing subfield, and subfields SF2 through SF8 are the selective initializing subfields. With the structure above, the light emission with no contribution to image display is only the light emission caused by the discharge in the all-cell initializing operation in subfield SF1. That is, the display area of luminance of black where luminance of black is displayed due to no sustain discharge has only weak light emission caused by the all-cell initializing operation. Thereby, an image of high contrast can be displayed on panel 10.

In the sustain period of each subfield, sustain pulses based on the luminance weight of the corresponding subfield multiplied by a predetermined proportionality factor are applied to respective display electrode pairs 24. This proportionality factor is a luminance magnification.

In each sustain period, sustain pulses equal in number to the luminance weight of the corresponding subfield multiplied by a predetermined luminance magnification are applied to respective scan electrodes 22 and sustain electrodes 23. Therefore, when the luminance magnification is 2, in the sustain period of a subfield having a luminance weight of 2, each of scan electrode 22 and sustain electrode 23 undergoes four-time application of sustain pulses. That is, the number of sustain pulses generated in the sustain period of the subfield is 8.

However, in this exemplary embodiment, the number of subfields forming one field, or the luminance weights of the respective subfields is not limited to the above values. Alternatively, the subfield structure may be switched in response to an image signal, for example.

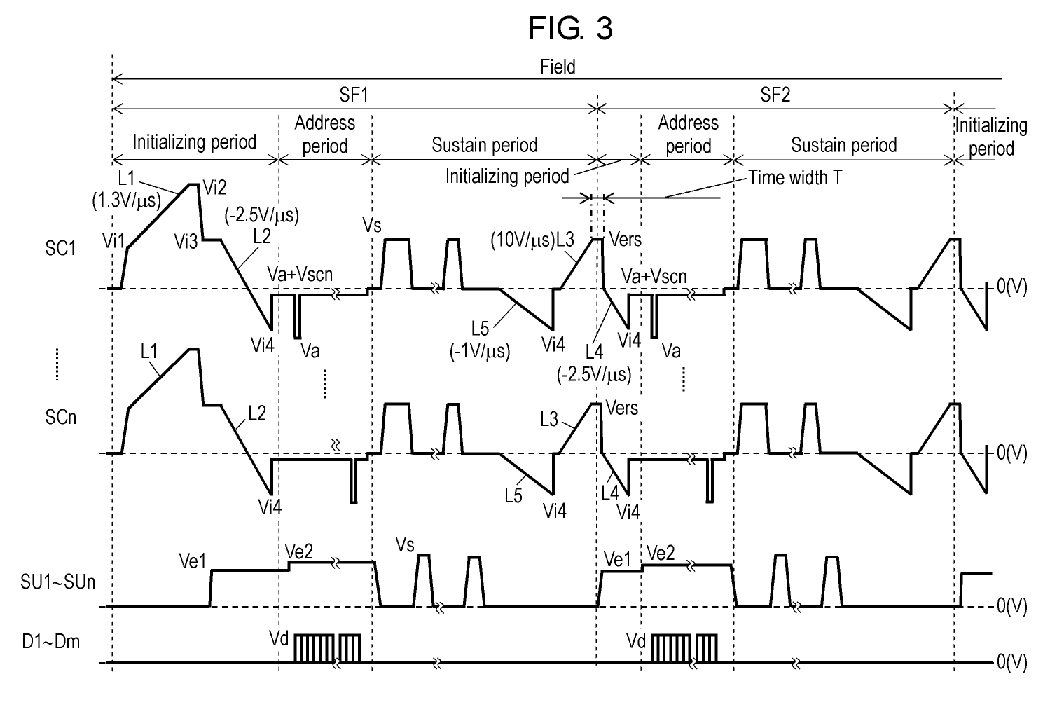

FIG. 3 is a chart of driving voltage waveforms applied to the respective electrodes of panel 10 for use in the plasma display apparatus in accordance with the exemplary embodiment of the present invention. Specifically, FIG. 3 shows driving voltage waveforms applied to scan electrode SC1 as the first scan electrode undergoes address operation in the address period, scan electrode SCn as the last scan electrode undergoes address operation in the address period, sustain electrodes SU1 through SUn, and data electrodes D1 through Dm.

It will also be noted that the driving voltage waveforms applied to scan electrodes SC1 through SCn in the initializing period are different between the two subfields shown in FIG. 3. In the two subfields, one is subfield SF1 as an all-cell initializing subfield, and the other is subfield SF2 as a selective initializing subfield. The driving voltage waveforms used for other subfields are similar to that of subfield SF2 except for the number of sustain pulses. Scan electrode SCi, sustain electrode SUi, and data electrode Dk in the following description are the electrodes selected from the respective electrodes, based on image data (i.e., data representing the light emission and no light emission in each subfield).

First, a description is provided for subfield SF1 as the all-cell initializing subfield.

In the first half of the initializing period of subfield SF1, voltage 0(V) is applied to data electrodes D1 through Dm, and sustain electrodes SU1 through SUn. Voltage Vi1 is applied to scan electrodes SC1 through SCn. Voltage Vi1 is set to a voltage lower than a discharge start voltage with respect to sustain electrodes SU1 through SUn. Further, a ramp waveform voltage gently rising from voltage Vi1 toward voltage Vi2 is applied to scan electrodes SC1 through SCn. Hereinafter, the ramp waveform voltage is referred to as ramp voltage L1. Voltage Vi2 is set to a voltage exceeding the discharge start voltage with respect to sustain electrodes SU1 through SUn. For example, the voltage gradient of ramp voltage L1 may be set to approximately 1.3V/μsec.

While ramp voltage L1 is increasing, a weak initializing discharge continuously occurs between scan electrodes SC1 through SCn and sustain electrodes SU1 through SUn, and between scan electrodes SC1 through SCn and data electrodes D1 through Dm. Through the discharge, negative wall voltage accumulates on scan electrodes SC1 through SCn, and positive wall voltage accumulates on data electrodes D1 through Dm and sustain electrodes SU1 through SUn. This wall voltage on the electrodes means voltages that are generated by the wall charge accumulated on the dielectric layers covering the electrodes, the protective layer, the phosphor layers, or the like.

In the second half of the initializing period, positive voltage Ve1 is applied to sustain electrodes SU1 through SUn, and voltage 0(V) is applied to data electrodes D1 through Dm. A first down-ramp voltage gently falling from voltage Vi3 to negative voltage Vi4 is applied to scan electrodes SC1 through SCn. Hereinafter, the first down-ramp voltage is referred to as ramp voltage L2. Voltage Vi3 is set to a voltage lower than the discharge start voltage with respect to sustain electrodes SU1 through SUn, and voltage Vi4 is set to a voltage exceeding the discharge start voltage. For example, the voltage gradient of ramp voltage L2 may be set to approximately −2.5V/μsec.

While ramp voltage L2 is applied to scan electrodes SC1 through SCn, a weak initializing discharge occurs between scan electrodes SC1 through SCn and sustain electrodes SU1 through SUn, and between scan electrodes SC1 through SCn and data electrodes D1 through Dm. This weak discharge reduces the negative wall voltage on scan electrodes SC1 through SCn and the positive wall voltage on sustain electrodes SU1 through SUn, and adjusts the positive wall voltage on data electrodes D1 through Dm to a value appropriate for the address operation. In this manner, the all-cell initializing operation for causing an initializing discharge in all the discharge cells is completed.

Hereinafter, the period having an all-cell initializing operation is referred to as an all-cell initializing period. Similarly, the driving voltage waveform for causing an all-cell initializing operation is referred to as an all-cell initializing waveform.

In the subsequent address period, a scan pulse of voltage Va is sequentially applied to scan electrodes SC1 through SCn. As for data electrodes D1 through Dm, an address pulse of positive voltage Vd is applied to data electrode Dk disposed at a discharge cell to be lit. Application of voltage above generates an address discharge selectively in the discharge cells.

Specifically, first, voltage Ve2 is applied to sustain electrodes SU1 through SUn, and voltage Vc is applied to scan electrodes SC1 through SCn.

Next, a scan pulse of negative voltage Va is applied to scan electrode SC1 in the first row that firstly undergoes the address operation. At the same time, an address pulse of positive voltage Vd is applied to data electrode Dk of a discharge cell to be lit in the first row in data electrodes D1 through Dm. Through the application of the pulses, the voltage difference in the intersecting part of data electrode Dk and scan electrode SC1 is calculated by adding the difference between the wall voltage on data electrode Dk and the wall voltage on scan electrode SC1 to the externally applied voltage difference (=voltage Vd−voltage Va). In this way, the voltage difference between data electrode Dk and scan electrode SC1 exceeds the discharge start voltage, generating a discharge between the two electrodes above.

As described above, voltage Ve2 is applied to sustain electrodes SU1 through SUn. Through the application of the voltage, the voltage difference between sustain electrode SU1 and scan electrode SC1 is calculated by adding the difference between the wall voltage on sustain electrode SU1 and the wall voltage on scan electrode SC1 to the externally applied voltage difference (=voltage Ve2−voltage Va). At this time, by setting voltage Ve2 at a voltage value just below the discharge start voltage, a “discharge-prone” state just before an actual discharge generation is formed between sustain electrode SU1 and scan electrode SC1.

The discharge generated between data electrode Dk and scan electrode SC1 triggers a discharge between sustain electrode SU1 and scan electrode SC1 that are disposed in the area intersecting to data electrode Dk. Thus, an address discharge occurs in the discharge cell to be lit. Positive wall voltage accumulates on scan electrode SC1, and negative wall voltage accumulates on sustain electrode SU1 and on data electrode Dk.

In this manner, address operation is performed to cause an address discharge in the discharge cells to be lit in the first row and to accumulate wall voltage on the respective electrodes. In contrast, because of no application of address pulses, the voltage of the intersecting part of scan electrode SC1 and data electrodes 32 does not exceed the discharge start voltage; accordingly, no address discharge occurs.

Next, a scan pulse is applied to scan electrode SC2 in the second row that secondary undergoes the address operation. At the same time, an address pulse is applied to data electrode Dk disposed at a discharge cell to be lit in the second row. In a discharge cell that undergoes the simultaneous application of the scan pulse and the address pulse, an address discharge is generated so as to perform an address operation.

In a similar way, the address operation is sequentially performed. On the completion of the address operation on the discharge cells in the n-th row, the address period is over. In the address period, as described above, an address discharge is selectively generated in a discharge cell to be lit, and wall charge is formed in the discharge cell.

In the subsequent sustain period, voltage 0(V) is applied to sustain electrodes SU1 through SUn, and at the same time, sustain pulses of positive voltage Vs are applied to scan electrodes SC1 through SCn. In the discharge cells having undergone the address discharge, the voltage difference between scan electrode SCi and sustain electrode SUi is calculated by adding the difference between the wall voltage on scan electrode SCi and the wall voltage on sustain electrode SUi to sustain pulse voltage Vs.

Thus, the voltage difference between scan electrode SCi and sustain electrode SUi exceeds the discharge start voltage and a sustain discharge occurs between scan electrode SCi and sustain electrode SUi. Ultraviolet rays generated by this discharge cause phosphor layers 35 to emit light. With this discharge, negative wall voltage accumulates on scan electrode SCi, and positive wall voltage accumulates on sustain electrode SUi. Positive wall voltage also accumulates on data electrode Dk. In the discharge cells having undergone no address discharge in the address period, no sustain discharge occurs and the wall voltage at the completion of the initializing period is maintained.

Subsequently, voltage 0(V) is applied to scan electrodes SC1 through SCn, and sustain pulses of voltage Vs are applied to sustain electrodes SU1 through SUn. In the discharge cells having undergone the sustain discharge, the voltage difference between sustain electrode SUi and scan electrode SCi exceeds the discharge start voltage. Thereby, a sustain discharge occurs again between sustain electrode SUi and scan electrode SCi. Negative wall voltage accumulates on sustain electrode SUi, and positive wall voltage accumulates on scan electrode SCi.

Similarly, sustain pulses are alternately applied to scan electrodes SC1 through SCn and sustain electrodes SU1 through SUn. The number of sustain pulses applied to the electrodes above corresponds to a number calculated by multiplying the luminance weight by a predetermined luminance magnification. The application of sustain pulses above continuously generates a sustain discharge in the discharge cells having undergone the address discharge in the address period.

After generation of sustain pulses in the sustain period, while voltage 0(V) is being applied to sustain electrodes SU1 through SUn and data electrodes D1 through Dm, a second down-ramp waveform voltage (hereinafter referred to erasing down-ramp voltage L5) is applied to scan electrodes SC1 through SCn. Erasing down-ramp voltage L5 gently falls from voltage 0(V) (that is lower than the discharge start voltage for data electrodes D1 through Dm) toward negative voltage Vi4 (that exceeds the discharge start voltage). In the embodiment, erasing down-ramp voltage L5 has a gradient of, for example, −1V/μsec, which is gentler than that of ramp voltage L2 (ramp voltage L4) generated in the initializing period.

In contrast, in a discharge cell having no address discharge and therefore no sustain discharge, a weak erasing discharge is generated between scan electrode SCh (h=1 to n except for i) and data electrode Dj (j=1 to m except for k). The weak discharge is continuously generated while the application voltage to scan electrodes SC1 through SCn is going down. After the falling voltage reached voltage Vi4, the voltage applied to scan electrodes SC1 through SCn is raised to voltage 0(V).

The weak erasing discharge generates charged particles, which accumulate on scan electrode SCh and data electrode Dj so as to reduce the voltage difference between scan electrode SCh and data electrode Dj. Thereby, an unnecessary amount of the wall voltage in the discharge cells is erased. That is, the discharge caused by erasing down-ramp voltage L5 serves as an erasing discharge for erasing unnecessary wall charge.

In a discharge cell having undergone no address discharge and no sustain discharge after generation of an initializing discharge, no discharge is generated before next address discharge. However, sustain pulses are also applied to display electrode pairs 24 of the discharge cells having undergo no sustain discharge. Charged particles (i.e., priming particles) formed by the sustain discharge generated in the neighboring discharge cells are attracted by the sustain pulses applied to display electrode pairs 24, particularly, by the voltage of the sustain pulses applied to scan electrode SCh. The attracted particles accumulate on scan electrode SCh as unwanted negative wall charge. The accumulation of unwanted wall charge easily occurs in the microscopic discharge cells of a high-definition panel. Besides, the greater the luminance weight (i.e. the number of the sustain pulses) a subfield has, the higher the tendency of accumulation.

An experiment shows that excessively accumulated unwanted wall charge can cause an abnormal discharge during the application of ramp voltage L4 to scan electrodes SC1 through SCn in the initializing period. If such an abnormal discharge is generated, the wall charge has a state different from the state having normal generation of initializing discharge, and further, unnecessary priming particles are generated. The abnormal state above can cause an address discharge in a discharge cell where the address discharge is not expected, deteriorating the quality of display image of the plasma display apparatus.

According to the structure of the embodiment, however, application of erasing down-ramp voltage L5 allows a weak erasing discharge to be generated between scan electrode SCh and data electrode Dj in a discharge cell having undergone no address discharge and no sustain discharge, by which unnecessary wall charge accumulated in the discharge cell is erased. Erasing unnecessary wall charge removes a cause of false discharge, preventing generation of discharge in a discharge cell where an address discharge is not expected.

Further, an experiment has shown the following facts on ramp voltage L2 and erasing down-ramp voltage L5. As for ramp voltage L2, the gentler the gradient of the ramp voltage has, the lower the occurrence of the abnormal discharge; however, an excessive gentleness in gradient is less effective in adjusting the wall charge to a proper level. Considering above, in the embodiment, ramp voltage L2 has a gradient of, for example, −2.5V/μsec. As for erasing down-ramp voltage L5, the gentler the gradient of the voltage has, the higher the effect on removing unnecessary wall charge (i.e., the effect on decreasing the abnormal discharge). Considering above, in the embodiment, erasing down-ramp voltage L5 has a gradient, for example, lower than −2.5V/μsec. However, further increase in gentleness of the gradient allows the effect above to be saturated. At the same time, the gentler the gradient of the ramp voltage has, the longer the time required for generating erasing down-ramp voltage L5. The gradient of erasing down-ramp voltage L5 should practically be at least −0.5V/μsec. Considering above, the gradient of erasing down-ramp voltage L5 in the embodiment is at least −0.5 V/μsec and is lower than −2.5V/μsec so as to be gentler than that of ramp voltage L2.

In the end of a sustain period, i.e., on the completion of application of erasing down-ramp voltage L5 to scan electrodes SC1 through SCn, an up-ramp voltage is applied to scan electrodes SC1 through SCn. The up-ramp voltage gradually rises from voltage 0(V) toward predetermined voltage Vers. Hereinafter, the up-ramp voltage is referred to as erasing up-ramp voltage L3. The application of erasing up-ramp voltage L3 allows a weak erasing discharge to be continuously generated in a discharge cell having undergone a sustain discharge. Through the discharge, wall charge accumulated on scan electrode SCi and sustain electrode SUi is partly or completely erased, while positive wall charge on data electrode Dk is maintained.

Specifically, erasing up-ramp voltage L3 is applied to scan electrodes SC1 through SCn, while voltage 0(V) is being applied to sustain electrodes SU1 through SUn and data electrodes D1 through Dm. Erasing up-ramp voltage L3 increases from voltage 0(V) as the base potential toward voltage Vers, with a gradient of, for example, approximately 10V/μsec, which is steeper than that of ramp voltage L1. Determining voltage Vers to a voltage exceeding the discharge start voltage allows a weak voltage to be generated between sustain electrode SUi and scan electrode SCi at a discharge cell having undergone a sustain discharge.

The weak discharge continuously generates while the voltage applied to scan electrodes SC1 through SCn is increasing over the discharge start voltage. After the increasing voltage reached predetermined voltage Vers, the voltage applied to scan electrodes SC1 through SCn is maintained at voltage Vers for a predetermined period of time. After that, the voltage is lowered down to voltage 0(V) as the base potential. That is, the voltage applied to scan electrodes 22 at the end of the sustain period has the following waveform: it increases from the base potential toward a predetermined voltage; after it reached the predetermined level, it is maintained at the level for a predetermined period of time; after that, it goes down toward the base potential. Hereinafter, the length of the predetermined period of time is also referred to time width T in the embodiment.

The weak discharge generates charged particles, which accumulate on sustain electrode SUi and scan electrode SCi so as to reduce the voltage difference between sustain electrode SUi and scan electrode SCi. Thereby, the wall voltage between scan electrodes SC1 through SCn and sustain electrodes SU1 through SUn is weakened to a voltage equivalent to the difference between the voltage applied to scan electrode SCi and the discharge start voltage (i.e., the voltage obtained by subtracting the discharge start voltage from voltage Vers, for example). That is, the discharge generated by erasing up-ramp voltage L3 serves as an erasing discharge.

After that, the voltage applied to scan electrodes SC1 through SCn is lowered to voltage 0(V). Thus, the sustain operation in the sustain period is completed. The aforementioned predetermined period of time for erasing up-ramp voltage L3 will be described later.

The driving voltage waveform used in the initializing period of subfield SF2 differs from that used in subfield SF1 in that the first half of the waveform is omitted. In the initializing period of subfield SF2, voltage Ve1 is applied to sustain electrodes SU1 through SUn, and voltage 0(V) is applied to data electrodes D1 through Dm. Ramp voltage L4 is applied to scan electrodes SC1 through SCn. Ramp voltage L4 gently falls from, for example, voltage 0(V) toward negative voltage Vi4 (, where, voltage 0V is lower than the discharge start voltage for scan electrodes SC1 through SCn, and voltage Vi4 exceeds the discharge start voltage). The gradient of ramp voltage L4 is, for example, approximately −2.5V/μsec, which is equivalent to that of ramp voltage L2.

With the application of voltage, a weak initializing discharge occurs in the discharge cells having undergone a sustain discharge in the sustain period of the immediately preceding subfield (i.e. subfield SF1 in FIG. 3). This weak discharge reduces the wall voltage on scan electrode SCi and sustain electrode SUi. The wall voltage accumulated on data electrode Dk is adjusted to a value appropriately for the address operation. In contrast, in the discharge cells having undergone no sustain discharge in the sustain period of the immediately preceding subfield, no initializing discharge occurs, and the wall charge at the completion of the initializing period of the immediately preceding subfield is maintained.

In this manner, in the initializing period of subfield SF2, a selective initializing operation is performed so as to selectively cause an initializing discharge in the discharge cells having undergone a sustain discharge in the sustain period of the immediately preceding subfield. Hereinafter, the period having a selective initializing operation is referred to as a selective initializing period.

According to the embodiment, as described above, the erasing discharge generated by erasing down-ramp voltage L5 removes unwanted wall charge that can invite abnormal discharge. The structure above prevents the aforementioned abnormal discharge from being generated in application of ramp voltage L4, and accordingly decreases the generation of false address discharge in a subfield where an address discharge is not expected.

Ramp voltage L4 works similar to ramp voltage L2. Therefore, ramp voltage L4 is, too, referred to as the first down-ramp voltage in the embodiment.

The driving voltage waveforms applied to each electrode in the address period and the sustain period of subfield SF2 are nearly the same as those used in the address period and the sustain period of subfield SF1, except for the number of the sustain pulses. Further, the driving voltage waveforms applied to each electrode in other subfields after subfield SF3 are nearly the same as those used in subfield SF2, except for the number of the sustain pulses.

The description above has provided an overview of the driving voltage waveforms applied to the electrodes of panel 10 of the embodiment.

The voltage to be applied to the respective electrodes in this exemplary embodiment includes the following values: voltage Vi1=145(V); voltage Vi2=350(V); voltage Vi3=190(V); voltage Vi4=−160(V); voltage Va=−180(V); voltage Vs=190(V); voltage Vers=190(V); voltage Ve1=125(V); voltage Ve2=125(V); and voltage Vd=60(V). Voltage Vc is determined by adding positive voltage Vscn (=145V) on negative voltage Va (=−180V); in that case, voltage Vc=−35(V). However, these voltage values are only examples. Preferably, each of the voltage values should be set appropriate for the characteristics of panel 10 and the specifications of the plasma display apparatus.

Next, the predetermined period of time for erasing up-ramp voltage L3 will be described in detail. In the embodiment, the predetermined period of time for erasing up-ramp voltage L3 in the current subfield is changed according to the number of sustain pulses generated in the sustain period of the immediately preceding subfield. The following explains the reason.

The inventor has found the fact below. That is, in the three discharge cells successively arranged in an extending direction of display electrode pairs 24 (hereinafter, simply referred to successive three discharge cells), non-lighting easily occurs in the middle discharge cell of the successive three discharge cells when each subfield has a certain lighting pattern (hereinafter, the pattern with high tendency of non-lighting is referred to as non-lighting generation pattern).

Specifically, the non-lighting generation pattern is the pattern that satisfies the following conditions: in the current subfield, the middle discharge cell of the successive three discharge cells is in the non-lighting state, whereas the two discharge cells located on the both sides of the middle discharge cell (hereinafter, both-side two discharge cells) are in the lighting state; and in the immediately before subfield and in immediately after subfield, the middle discharge cell is in the lighting state.

The inventor has guessed that, when the lighting pattern of each subfield in successive three discharge cells satisfies the conditions above, the wall charge of a discharge cell having no address discharge in the current subfield, i.e., the wall charge of the middle discharge cell decreases by the address discharge generated in the both-side two discharge cells—the middle discharge cell has the escape of electric charge. It is considered that the escape of electric charge occurs in the middle discharge cell.

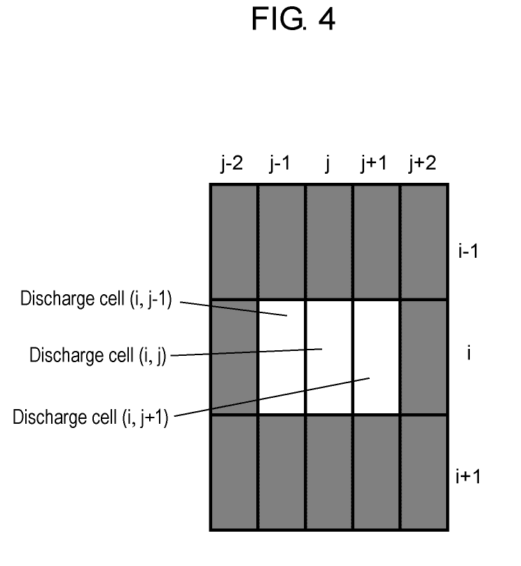

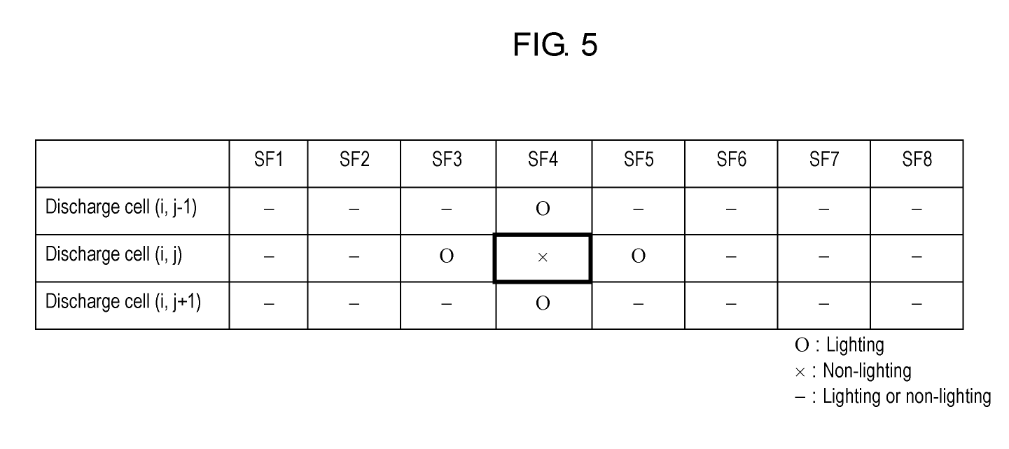

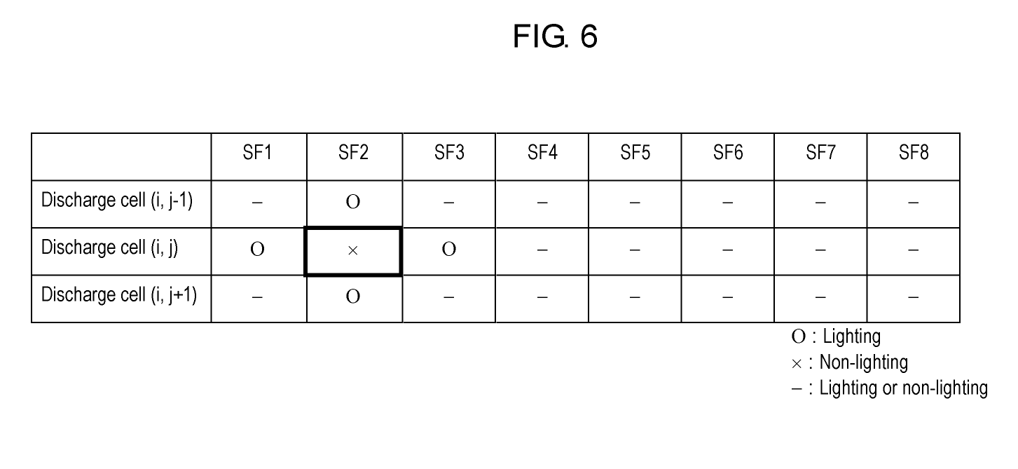

The non-lighting generation pattern will be described with reference to the drawings. FIG. 4 schematically shows the discharge cells formed in panel 10 of the plasma display apparatus in accordance with the exemplary embodiment. Each of FIGS. 5 and 6 shows an example of the non-lighting generation pattern occurred in discharge cell (i, j−1), discharge cell (i, j), and discharge cell (i, j+1) of FIG. 4.

FIG. 4 shows the discharge cells located in three rows of i−1, i, and i+1, and located in five columns from j−2 to j+2, that is, 3×5 (=15) discharge cells. In the description below, the discharge cell located in i-th row and in j-th column is represented by discharge cell (i, j). In FIGS. 5 and 6, ‘o’ shows that the discharge cell is in the lighting state, and ‘×’ shows that the discharge cell is in the non-lighting state. Further, ‘-’ shows that the discharge cell is in either of the two states (lighting state and non-lighting state).

In the example below, successive three discharge cells are described as discharge cell (i, j−1), discharge cell (i, j), and discharge cell (i, j+1) of FIG. 4. Discharge cell (i, j) is the middle discharge cell, and discharge cell (i, j) and discharge cell (i, j+1) are both-side two discharge cells. FIG. 5 shows an example where SF4 is the current subfield, whereas FIG. 6 shows an example where SF2 is the current subfield.

In the example of FIG. 5 where the current subfield is SF4, discharge cell (i, j) is in the non-lighting state, whereas discharge cell (i, j−1) and discharge cell (i, j+1) are both in the lighting state. At the same time, discharge cell (i, j) is in the lighting state not only in SF3 as the subfield immediately before the current subfield but also in SF5 as the subfield immediately after the current subfield. Discharge cells of the subfields other than those mentioned above may be in the lighting state or non-lighting state. In the aforementioned lighting pattern, the escape of electric charge easily occurs in discharge cell (i, j) in SF4 as the current subfield, by which the address discharge generated in discharge cell (i, j) in the immediately after subfield (SF5) tends to lose stability.

In the example of FIG. 6 where the current subfield is SF2, discharge cell (i, j) is in the non-lighting state, whereas discharge cell (i, j−1) and discharge cell (i, j+1) are both in the lighting state. At the same time, discharge cell (i, j) is in the lighting state not only in SF1 as the subfield immediately before the current subfield but also in SF3 as the subfield immediately after the current subfield. Discharge cells of the subfields other than those mentioned above may be in the lighting state or non-lighting state. In the aforementioned lighting pattern, the escape of electric charge easily occurs in discharge cell (i, j) in SF2 as the current subfield, by which the address discharge generated in discharge cell (i, j) in the immediately after subfield (SF3) tends to lose stability.

In the examples described above, if a sufficient amount of wall charge has been accumulated in the middle discharge cell in the subfield immediately before the current subfield, some amounts of escape of electric charge in the current subfield have little effect on generating stable address discharge in the subfield immediately after the current subfield. In contrast, if the middle discharge cell has a poor amount of wall charge in the subfield immediately before the current subfield, decrease in wall charge due to the escape of electric charge in the current subfield adversely affects the stability of the address discharge generated in the subfield immediately after the current subfield.

It is considered that the wall charge is partly formed by generation of sustain discharge. That is, the amount of wall charge at the start of an address period of a subfield depends on the number of generation of sustain discharge in the sustain period of the immediately before subfield.

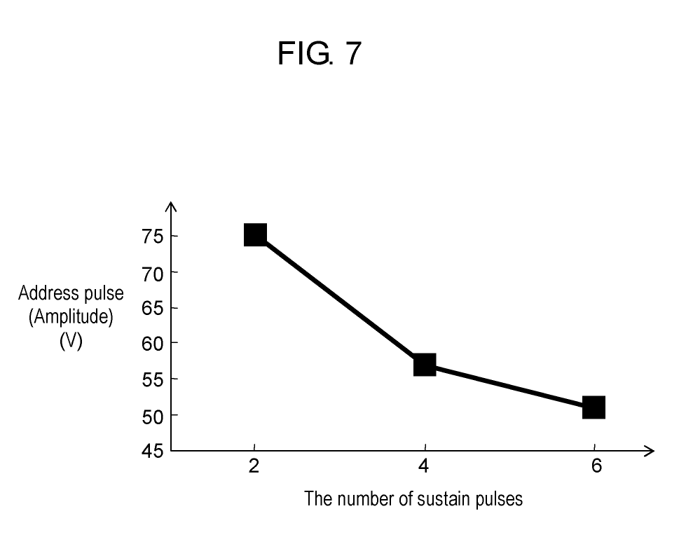

FIG. 7 is a graph showing the relation between the amplitude of address pulses necessary for generating a stable address discharge in the current subfield and the number of sustain pulses generated in the immediately before subfield in the plasma display apparatus in accordance with the embodiment. In FIG. 7, the horizontal axis represents the number of sustain pulses generated in the sustain period of the subfield immediately before the current subfield. For example, ‘2’ (on the horizontal axis) represents that each of scan electrodes 22 and sustain electrodes 23 undergoes one-time application of the sustain pulses. The vertical axis of the graph represents amplitude (V) of the address pulses necessary for generating a stable address discharge in the current subfield.

As is apparent from FIG. 7, the higher the number of the sustain pulses generated in the subfield immediately before the current subfield, the smaller the amplitude of the address pulses necessary for generating stable address discharge in the current subfield. FIG. 7 shows the following result on the relation between the amplitude of the address pulses necessary for generating a stable address discharge in the current subfield and the number of sustain pulses generated in the immediately before subfield: the number of sustain pulses of 2 for amplitude of 75(V); the number of sustain pulses of 4 for amplitude of 57(V); and the number of sustain pulses of 6 for amplitude of 51(V).

From the result, it is considered that increase in number of the sustain pulses increases the amount of wall charge formed in the discharge cells. Therefore, if a sufficient amount of wall charge has been accumulated in the subfield immediately before the current subfield, some amounts of escape of electric charge in the current subfield have little effect on generating a stable address discharge in the subfield immediately after the current subfield.

In the examples of FIGS. 5 and 6 (where, subfields SF1 through SF8 have following luminance weight: 1, 2, 4, 8, 16, 32, 64, and 128), the address discharge generated in discharge cell (i, j) in SF5 of FIG. 5 is more stable than the address discharge generated in discharge cell (i, j) in SF3 of FIG. 6.

The inventor has further found a correlation between the followings from an experiment. That is, the length of time (time width T) for erasing up-ramp voltage L3 in the current subfield is relevant to the amplitude of the address pulses necessary for generating a stable address discharge in the address period of the immediately after subfield.

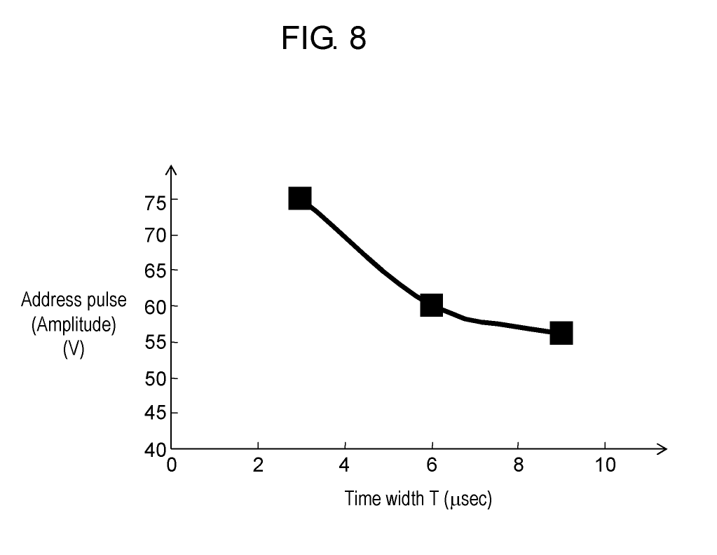

FIG. 8 is a graph showing a relation between the length of time for erasing ramp voltage L3 in the current subfield and the amplitude of address pulses necessary for generating a stable address discharge in the immediately after subfield in the plasma display apparatus in accordance with the exemplary embodiment. In FIG. 8, the horizontal axis of the graph represents the length of time (hereinafter, time width T) for erasing up-ramp voltage L3 in the current subfield. The vertical axis represents amplitude (V) of the address pulses necessary for generating a stable address discharge in the immediately after subfield.

The result of FIG. 8 was obtained by the measurement with the following conditions: the number of the sustain pulses generated in SF1 was 2; SF2 as the current subfield was in the non-lighting state. The inventor measured the amplitude of the address pulses necessary for generating a stable address discharge in SF3 as the subfield immediately after the current subfield, while changing time width T for erasing up-ramp voltage L3 in the current subfield.

Through the experiment, the inventor obtained the following result on relation between time width T and the amplitude of the address pulses necessary for generating a stable address discharge: time width T of 3 μsec for an amplitude of 75(V); time width T of 6 μsec for an amplitude of 60(V); and time width T of 9 μsec for an amplitude of 55(V).

The measurement result has proved that, the longer time width T, the smaller the amplitude of the address pulses necessary for generating a stable address discharge in SF3. As is apparent from the experiment, increase in time width T for erasing up-ramp voltage L3 in the current subfield allows a stable address discharge to be generated in SF3 as the subfield immediately after the current subfield, even if some amount of the escape of electric charge occurs in the current subfield.

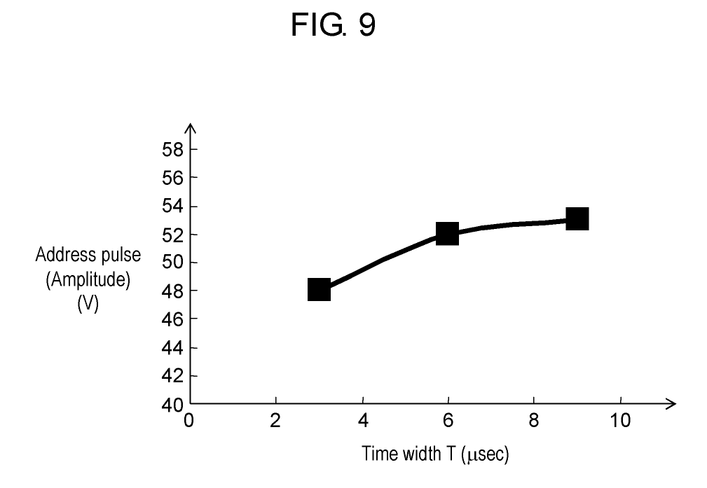

FIG. 9 is another graph showing a relation between time width T for erasing ramp voltage L3 in the current subfield and the amplitude of address pulses necessary for generating a stable address discharge in the immediately after subfield in the plasma display apparatus in accordance with the exemplary embodiment. In FIG. 9, the horizontal axis of the graph represents time width T for erasing up-ramp voltage L3 in the current subfield. The vertical axis represents amplitude (V) of the address pulses necessary for generating a stable address discharge in the immediately after subfield.

The result of FIG. 9 was obtained by the measurement with the following conditions: the number of the sustain pulses generated in SF2 was 6; SF3 as the current subfield was in the non-lighting state. The inventor measured the amplitude of the address pulses necessary for generating a stable address discharge in SF4 as the subfield immediately after the current subfield, while changing time width T for erasing up-ramp voltage L3 in the current subfield.

Through the experiment, the inventor obtained the following result on relation between time width T and the amplitude of the address pulses necessary for generating a stable address discharge: time width T of 3 μsec for an amplitude of 48(V); time width T of 6 μsec for an amplitude of 52(V); and time width T of 9 μsec for an amplitude of 53(V).

Unlike the result shown in FIG. 8, the graph shows increase in amplitude of the address pulses. That is, in the case where the number of sustain pulses generated in SF2 increases, lengthened time width T increases the amplitude of the address pulses necessary for generating a stable address discharge in SF4. From the result above, in the case where the sustain pulses have increase in number generated in the subfield immediately before the current subfield, time width T for erasing up-ramp voltage L3 in the current subfield should not be increased.

Considering the results of the experiment, in the embodiment, time width T for erasing up-ramp voltage L3 in the current subfield is changed according to the number of the sustain pulses generated in the immediately before subfield. That is, when the number of the sustain pulses generated in the subfield immediately before the current subfield is not greater than a predetermined threshold, the current subfield has time width T for erasing up-ramp voltage L3 longer than that of other subfields. For example, when the threshold is determined to ‘3’, in the structure where SF1 through SF8 have a sustain pulse of 2, 4, 8, 16, 32, 64, 128, and 256, SF1 immediately before SF2 has the number of the sustain pulses lower than the threshold. In that case, time width T for erasing up-ramp voltage L3 in SF2 is determined to be longer than that in other subfields.

The structure above provides an address discharge with stability, even if the aforementioned non-lighting generation pattern occurs in displaying image on panel 10.

In the embodiment, when the number of the sustain pulses generated in the subfield immediately before the current subfield is not greater than the threshold, the current subfield has time width T of 6 μsec and other subfields have time width T of 3 μsec. However, the values are cited merely by way of example. These values should be set optimally for the characteristics of the panel and the specifications of the plasma display apparatus.

Although the example of the embodiment employs a threshold of 3, the value is cited merely by way of example. The threshold should be set optimally for the characteristics of the panel and the specifications of the plasma display apparatus.

Next, the structure of the plasma display apparatus of the embodiment will be described.

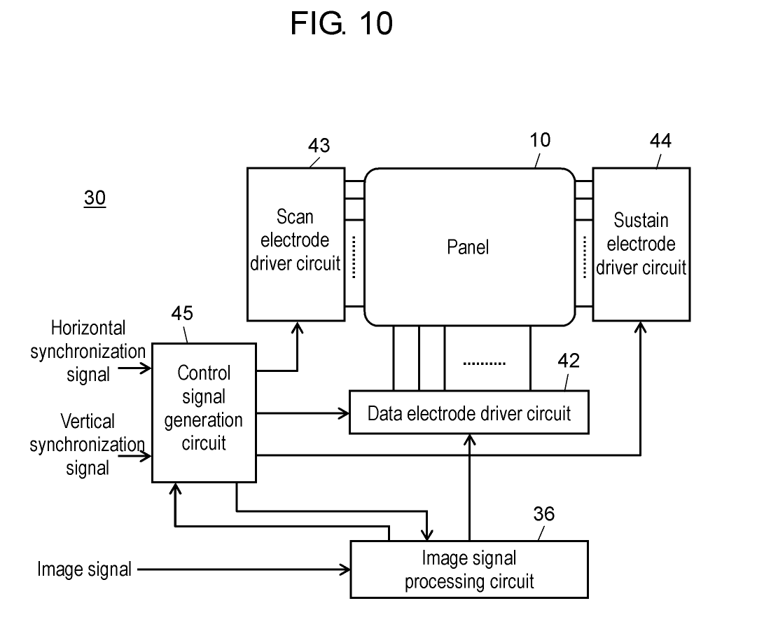

FIG. 10 is a circuit block diagram of plasma display apparatus 30 in accordance with the exemplary embodiment. Plasma display apparatus 30 has panel 10 and a driver circuit. The driver circuit includes image signal processing circuit 36, data electrode driver circuit 42, scan electrode driver circuit 43, sustain electrode driver circuit 44, control signal generation circuit 45, and a power supply circuit (not shown) for supplying electric power to each block.

Image signal processing circuit 36 allocates gradation values to each discharge cell, based on input image signal sig. Image signal processing circuit 36 converts the gradation values into image data representing light emission or no light emission (where, light emission and no light emission correspond to ‘1’ and ‘0’, respectively, of digital signals) in each subfield.

For instance, when input image signal sig includes R signal, G signal, and B signal, R, G, and B gradation values are allocated to the respective discharge cells, based on the R signal, G signal, and B signal. When the input image signal includes luminance signal (Y signal) and chroma signal (C signal, R-Y signal and B-Y signal, u signal and v signal, or the like), the R signal, the G signal, and the B signal are calculated based on the luminance signal and the chroma signal, and thereafter the R, G, and B gradation values (gradation values represented in one field) are allocated to the respective discharge cells. Then, the R, G, and B gradation values allocated to the respective discharge cells are converted into image data representing light emission or no light emission in each subfield.

Based on a horizontal synchronization signal and a vertical synchronization signal, control signal generation circuit 45 generates control signals for controlling the operation of each circuit block and supplies the generated control signals to respective circuit blocks (e.g. data electrode driver circuit 42, scan electrode driver circuit 43, sustain electrode driver circuit 44). In addition, receiving image data from image signal processing circuit 36, control signal generation circuit 45 detects a subfield in which the number of the sustain pulses is not greater than a predetermined threshold, and generates a control signal according to the detection. That is, control signal generation circuit 45 generates a control signal such that time width T for erasing up-ramp voltage L3 is prolonged by a predetermined period of time in the subfield that immediately follows the subfield in which the number of the sustain pulses is not greater than the threshold.

Scan electrode driver circuit 43 has an initializing waveform generation circuit, a sustain pulse generation circuit, and a scan pulse generation circuit (not shown). Scan electrode driver circuit 43 drives scan electrodes SC1 through SCn, based on the control signals fed from control signal generation circuit 45. Based on the control signals, the initializing waveform generation circuit generates an initializing waveform to be applied to scan electrodes SC1 through SCn in the initializing period. Further, based on the control signals, the initializing waveform generation circuit generates erasing up-ramp voltage L3 to be applied to scan electrodes SC1 through SCn in the sustain period. In response to the control signals, the sustain pulse generation circuit generates sustain pulse to be applied to scan electrodes SC1 through SCn in the sustain period. The scan pulse generation circuit has a plurality of scan electrode driver ICs (scan ICs). In response to the control signals, the scan pulse generation circuit generates scan pulses to be applied to scan electrodes SC1 through SCn in the address period.

Sustain electrode driver circuit 44 has a sustain pulse generation circuit, and a circuit for generating voltage Ue1 and voltage Ve2 (not shown). In response to the control signals supplied from control signal generation circuit 45, sustain electrode driver circuit 44 drives sustain electrodes SU1 through SUn. In a sustain period, sustain electrode driver circuit 44 generates sustain pulses in response to the control signals and applies the sustain pulses to sustain electrodes SU1 through SUn.

Data electrode driver circuit 42 converts data that forms image data for each subfield into signals corresponding to each of data electrodes D1 through Dm. Based on the converted signal and the control signals fed from control signal generation circuit 45, data electrode driver circuit 42 drives data electrodes D1 through Dm. In an address period, data electrode driver circuit 42 generates address pulses according to the control signal, and applies them to data electrodes D1 through Dm.

Next, the structure of scan electrode driver circuit 43 is described.

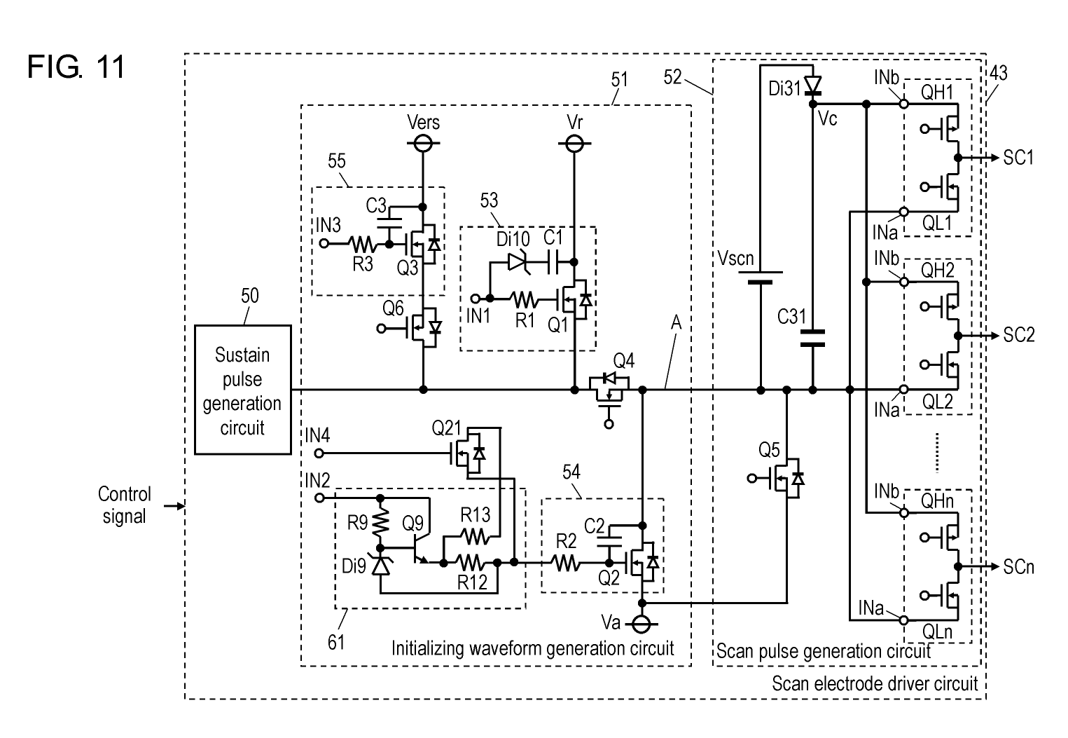

FIG. 11 is a circuit diagram showing the structure of scan electrode driver circuit 43 of plasma display apparatus 30 in accordance with the exemplary embodiment. Scan electrode driver circuit 43 has sustain pulse generations circuit 50 disposed on the side of scan electrodes 22, initializing waveform generation circuit 51, and scan pulse generation circuit 52. Each of the output terminals of scan pulse generation circuit 52 is connected to scan electrodes SC1 through SCn of panel 10 so as to apply scan pulses separately to each of scan electrodes 22 in the address period.

In the embodiment, for the sake of convenience, the voltage fed into scan pulse generation circuit 52 is referred to reference potential A. Hereinafter, operating a switching element so as to establish electrical connections is represented by “turning on a switching element” and operating a switching element so as to break electrical connections is represented by “turning off a switching element”. Further, the signal that turns on a switching element is referred to signal Hi, and the signal that turns off a switching element is referred to signal Lo. A detailed signal path of control signals is not shown in FIG. 11.

FIG. 11 shows a separation circuit employing switching element Q4. When a circuit using negative voltage Va (e.g., Miller integration circuit 54) is in operation, operating switching element Q4 allows the circuit above to electrically separate from sustain pulse generation circuit 50, a circuit using voltage Vr (e.g., Miller integration circuit 53), and a circuit using voltage Vers (e.g., Miller integration circuit 55). FIG. 11 also shows a separation circuit employing switching element Q6. When a circuit using voltage Vr (e.g., Miller integration circuit 53) is in operation, operating switching element Q6 allows the circuit above to electrically separate from a circuit (e.g., Miller integration circuit 55) using voltage Vers that is lower than voltage Vr.

Sustain pulse generation circuit 50 has an ordinary power recovery circuit and a clamping circuit (not shown). The power recovery circuit has a power-recovery capacitor and a resonance inductor. Rise and decay of sustain pulses are obtained by LC resonance of inter-electrode capacitance of panel 10 and the inductor. The clamping circuit clamps reference potential A not only to the base potential, i.e., voltage zero (0V) but also to voltage Vs. In response to the control signal fed from control signal generation circuit 45, sustain pulse generation circuit 50 switches the operation between the power recovery circuit and the clamping circuit, allowing reference potential A fed into sustain electrode driver circuit 52 to set to voltage Vs or to the ground potential i.e. voltage 0(V). The sustain pulses are thus generated.

Sustain electrode driver circuit 44 (not shown) has a sustain pulse generation circuit with a structure similar to sustain pulse generation circuit 50. In response to the control signal fed form control signal generation circuit 45, the sustain pulse generation circuit switches the switching elements disposed therein and generates sustain pulses. The sustain pulses are applied to n sustain electrodes (sustain electrodes SU1 through SUn).

Scan pulse generation circuit 52 has switching element Q5, power supply VSCN, diode Di31, capacitor C31, switching elements QH1 through QHn, and switching elements QL1 through QLn. Switching element Q5 connects reference potential A to negative voltage Va. Power supply VSCN generates voltage Vc that is obtained by adding voltage Vscn on reference potential A. Switching elements QH1 through QHn apply voltage Vc to each of scan electrodes SC1 through SCn, whereas switching elements QL1 through QLn apply reference potential A to each of scan electrodes SC1 through SCn.

Switching elements QH1 through QHn and QL1 through QLn are grouped by output and formed into ICs (i.e., scan ICs). Scan pulse generation circuit 52 has scan ICs for generating scan pulses to be applied to scan electrodes SC1 through SCn. As described above, forming many switching elements (switching elements QH1 through QHn and QL1 through QLn) into ICs allows the circuit structure to be compact, decreasing the area occupied by the circuits on the printed-circuit board. Besides, the structure contributes to cost-reduced production of plasma display apparatus 30.

Each input terminal INb of switching elements QH1 through QHn is connected to voltage Vc, whereas each input terminal INa of switching elements QL1 through QLn is connected to reference potential A.

In scan pulse generation circuit 52 structured above, switching element Q5 is turned on in an address period so that reference potential A is connected to negative voltage Va. Through the switching control, negative voltage Va is applied to input terminal INa, while voltage Vc (voltage Va+voltage Vscn) is applied to input terminal INb. In addition, according to the control signal fed from control signal generation circuit 45, scan electrodes undergo application of voltage by the following switching control. As for scan electrode SCi to which a scan pulse is applied, a scan pulse of negative voltage Va is applied to the electrode via switching element QLi by turning off switching element QHi and turning on switching element QLi. As for scan electrode SCh (where, h takes 1 to n except for i) to which no scan pulse is applied, voltage Va+voltage Vscn is applied to the electrode via switching element QHh by turning off switching element QLh and turning on switching element QHh.

Initializing waveform generation circuit 51 has Miller integration circuits 53, 54, 55 and constant current generation circuit 61. Miller integration circuits 53 and 55 are the up-ramp voltage generation circuits for generating voltage having an up-ramp waveform, whereas Miller integration circuit 54 is the down-ramp voltage generation circuit for generating voltage having a down-ramp waveform. In FIG. 11, the input terminal of Miller integration circuit 53 is shown as input terminal IN1, the input terminal of Miller integration circuit 55 is shown as input terminal IN3, and the input terminal of constant current generation circuit 61 is shown as input terminal IN2.

Miller integration circuit 53 has switching element Q1, capacitor C1, resistor R1, and zener diode Di10 connected in series to capacitor C1. With the structure above, Miller integration circuit 53 raises reference potential A of scan electrode driver circuit 43 to voltage Vi2 with a moderate gradient of (for example, 1.3V/μsec) so as to generate ramp voltage L1 in an initializing operation. Zener diode Di10 generates voltage Vi1 by adding zener voltage (e.g. 45V) onto voltage Vscn in the initializing operation in the initializing period of subfield SF1). That is, the starting voltage (from which the ramp voltage starts to rise) of ramp voltage L1 is set to voltage Vi1 by zener diode Di10. The zener voltage of zener diode Di10 has a voltage that is added on reference potential A.

Voltage Vi2 is set to a voltage obtained by adding voltage Vscn onto voltage Vr. That is, while up-ramp voltage L1 is being generated, switching elements QH1 through QHn are turned on and switching elements QL1 through QLn are turned off. Through the switching control above, a voltage obtained by adding the output voltage from initializing waveform generation circuit 51 on voltage Vscn is applied to scan electrodes SC1 through SCn via switching elements QH1 through QHn.

Miller integration circuit 55 has switching element Q3, capacitor C3, and resistor R3. With the structure above, at the end of a sustain period, Miller integration circuit 55 raises reference potential A, with a gradient steeper than that of ramp voltage L1 (e.g. 10V/μsec), to voltage Vers so as to generate erasing up-ramp voltage L3.

Miller integration circuit 54 has switching element Q2, capacitor C2, and resistor R2. With the structure above, in an initializing operation, Miller integration circuit 54 moderately lowers (with a gradient of −2.5V/μsec, for example,) reference potential A down to voltage Vi4 so as to generate ramp voltage L2 and ramp voltage L4. Further, after generation of the sustain pulses in a sustain period, Miller integration circuit 54 moderately lowers (with a gradient of −1V/μsec, for example,) reference potential A down to voltage Vi4 so as to generate erasing down-ramp voltage L5.

Constant current generation circuit 61 has transistor Q9, resistor R9, zener diode Di9, and resistor R12. The collector of transistor Q9 is connected to input terminal IN2. Resistor R9 is disposed between input terminal IN2 and the base of transistor Q9. Zener diode Di9 has the cathode connected to resistor R9 and the anode connected to resistor R2. Resistor R12 is disposed in series between the emitter of transistor Q9 and resistor R2. With application of a voltage (e.g. 5V) to input terminal IN2, constant current generation circuit 61 generates constant current and sends it to Miller integration circuit 54. While receiving the constant current, Miller integration circuit 54 lowers reference potential A.

Initializing waveform generation circuit 51 of the embodiment contains switching element Q21 having input terminal IN4 as a gate. Switching element 21 turns on in response to a control signal of Hi (e.g. 5V) applied to input terminal IN4, and it turns off in response to a control signal of Lo (e.g. 0V) applied to input terminal IN4. Constant current generation circuit 61 contains resistor R13. Through the switching operation of switching element Q21, resistor R13 changes the current value of the constant current fed from constant current generation circuit 61. Specifically, one terminal of resistor R13 is connected to the connecting point of resistor R12 and transistor Q9, and the other terminal thereof is connected to the drain of switching element Q21. The source of switching element Q21 is connected to the connecting point of resistor R12 and resistor R2. With the structure above, turning on switching element Q21 establishes electrical connections of resistor R12 and resistor R13 in parallel. Compared to the off-state of switching element Q21, constant current generation circuit 61 has an increased output value of constant current, and Miller integration circuit 54 has an increased gradient of the ramp waveform voltage in the on-state of switching element Q21.

The structure above allows Miller integration circuit 54 to generate following two ramp waveform voltages having difference in gradient: ramp voltage L2 generated in the initializing operation; and erasing down-ramp voltage L5 generated after generation of the sustain pulses in the sustain period.

The signals for controlling each circuit are fed from control signal generation circuit 45.

Control signal generation circuit 45 effects control of scan pulse generation circuit 52 in a manner so as to output, in an initializing period, the voltage waveform fed from initializing waveform generation circuit 51 and so as to output, in a sustain period, the voltage waveform fed from sustain pulse generation circuit 50. That is, while initializing waveform generation circuit 51 or sustain pulse generation circuit 50 is in operation, switching elements QH1 through QHn are turned off and switching elements QL1 through QLn are turned on in scan pulse generation circuit 52. Through the switching control, an initializing waveform or a sustain pulse is applied to scan electrodes SC1 through SCn via switching elements QL1 through QLn. When the voltage obtained by adding voltage Vscn on the output voltage from initializing waveform generation circuit 51 is applied to scan electrodes SC1 through SCn, switching elements QH1 through QHn are turned on and switching element QL1 through QLn are turned off. Through the switching control, an initializing waveform is applied to scan electrodes SC1 through SCn via switching elements QH1 through QHn.

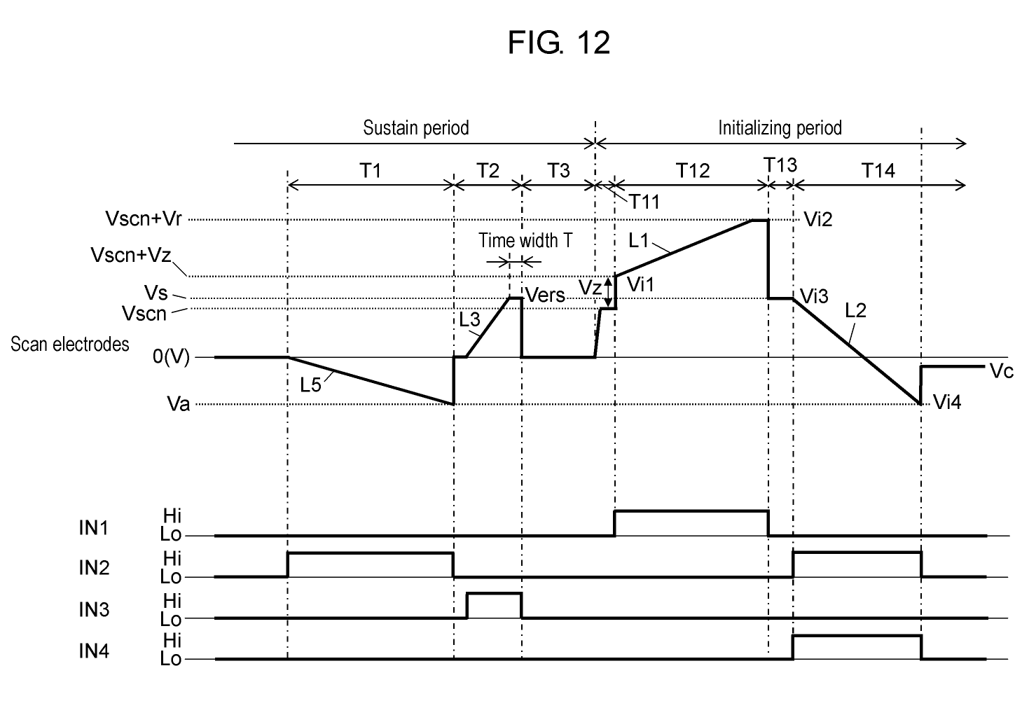

Next, the workings of the scan electrode driver circuit to generate each ramp voltage will be described with reference to FIG. 12.

FIG. 12 is a timing chart showing an example of the workings of the scan electrode driver circuit in an all-cell initializing period in accordance with the exemplary embodiment. FIG. 12 shows the voltage waveform generated in an all-cell initializing operation. The workings of the scan electrode driver circuit to generate ramp voltage L4 in a selective initializing operation is similar to that to generate ramp voltage L2 shown in FIG. 12.

In the description below, the voltage waveform generated after generation of the sustain pulses in the sustain period is divided into three: period T1 through period T3, whereas the voltage waveform generated in an all-cell initializing operation is divided into four: period T11 through period T14. In the description, voltage Vi3 and voltage Vers are equivalent to voltage Vs; voltage Vi2=voltage Vscn+voltage Vr; and voltage Vi4 is equivalent to negative voltage Va. Further, ‘Hi’ in the timing chart represents a signal that turns on a switching element, while ‘Lo’ represents a signal that turns off a switching element.

First, erasing down-ramp voltage L5 is generated after generation of the sustain pulses in the sustain period, and after that, erasing up-ramp voltage L3 is generated. The process of generating the ramp voltage will be described.

Before period T1 starts, the clamp circuit of sustain pulse generation circuit 50 clamps reference potential A to voltage 0(V). Switching elements QH1 through QHn are turned off, whereas switching elements QL1 through QLn are turned on. Reference potential A (clamped to 0V) is applied to scan electrodes SC1 through SCn (not shown).

<period T1>

In period T1, switching element Q21 is turned off by setting input terminal IN4 in ‘Lo’. Through the switching control, resister R13 carries no current. At the same time, input terminal IN2 is set in ‘Hi’. Through the switching control, constant current generation circuit 61 starts working, by which a constant current flows toward capacitor C2. The drain voltage of switching element Q2 goes down, with a ramp waveform, toward negative voltage Vi4 (=voltage Va, in the embodiment). Similarly, the output voltage of scan electrode driver circuit 43 goes down, with a ramp waveform, toward negative voltage Vi4. The resistance value of resistor R12 is determined in advance so that the gradient of the ramp waveform voltage has an intended value (for example, −1V/μsec).

The ramp voltage keeps falling while input terminal IN2 is kept in ‘Hi’ or until reference potential A reaches voltage Va. In the embodiment, when the output voltage of scan electrode driver circuit 43 reaches negative voltage Vi4 (voltage Va, in the embodiment), input terminal IN2 is set in ‘Lo’ by applying, for example, voltage 0(V) to input terminal IN2.

As described above, in the embodiment, erasing down-ramp voltage L5 that falls to voltage Vi4 is generated after the sustain pulses have been generated in the sustain period, and the erasing voltage is applied to scan electrodes SC1 through SCn.

While erasing down-ramp voltage L5 is falling, the voltage difference between scan electrode SCh and data electrode Dj exceeds the discharge start voltage, generating a weak discharge between the electrodes above. The weak discharge continuously generates while erasing down-ramp voltage L5 is falling.

<period T2>

In period T2, input terminal IN3 of Miller integration circuit 55 that generates erasing up-ramp voltage L3 is set in ‘Hi’. To be specific, a predetermined constant current is fed into input terminal IN3, by which a constant current flows toward capacitor C3. In response to the current flow, the source voltage of switching element Q3 has increase with a ramp waveform, increasing the output voltage of scan electrode driver circuit 43 with a ramp waveform. The value of the current to be fed into input terminal IN3 is determined in advance so that the gradient of the ramp waveform voltage has an intended value (for example, 10V/μsec). Through the process above, Miller integration circuit 55 generates erasing up-ramp voltage L3, which increases from voltage 0(V) toward voltage Vers (voltage Vs, in the embodiment), and applies the erasing voltage to scan electrodes SC1 through SCn. The ramp voltage keeps rising while input terminal IN3 is kept in ‘Hi’ or until reference potential A reaches voltage Vers.

While erasing up-ramp voltage L3 is rising, the voltage difference between scan electrode SCi and sustain electrode SUi exceeds the discharge start voltage, generating a weak discharge between the electrodes above. The weak discharge continuously generates while erasing up-ramp voltage L3 is rising.

Meanwhile, the voltage applied to data electrodes D1 through Dm (not shown) is clamped to voltage 0(V). Positive wall charge is formed on data electrode Dk.

When reference potential A reaches voltage Vers, it is kept at the level for the period of time width T. After that, input terminal IN3 is set in ‘Lo’, and the clamp circuit of sustain pulse generation circuit 50 lowers reference potential A to voltage 0(V). The control signal generated by control signal generation circuit 45 determines the timing of changes above, controlling time width T for erasing up-ramp voltage L3.

<period T3>

In period T3, the clamp circuit of sustain pulse generation circuit 50 clamps reference potential A to voltage 0(V) for the successive all-cell initializing operation.

Next, the workings for generating initializing waveform voltage in an all-cell initializing period will be described.

<period T11>

In period T11, switching elements QH1 through QHn are turned on, whereas switching elements QL1 through QLn are turned off. Through the switching control above, a voltage obtained by adding voltage Vscn on reference potential A (kept at voltage 0) is applied to scan electrodes SC1 through SCn.

<period T12>

Next, input terminal IN1 of Miller integration circuit 53 that generates ramp voltage L1 is set in ‘Hi’. To be specific, a predetermined constant current is fed into input terminal IN1. At the start of working of Miller integration circuit 53, the source voltage of switching element Q1 has voltage Vz obtained by adding zener voltage Vz of zener diode Di10 onto reference potential A of voltage 0(V). Accordingly, the output voltage of scan electrode driver circuit 43 sharply increases from voltage Vscn to voltage Vi1 obtained by adding zener voltage Vz of zener diode Di10 onto voltage Vscn.

After that, a constant current flows toward capacitor C1. In response to the current flow, the source voltage of switching element Q1 has increase with a ramp waveform, increasing the output voltage of scan electrode driver circuit 43 with a ramp waveform. The value of the current to be fed into input terminal IN1 is determined in advance so that the gradient of the ramp waveform voltage has an intended value (for example, 1.3V/μsec).

Through the process above, Miller integration circuit 53 generates ramp erasing voltage L1, which increases from voltage Vi1 toward voltage Vi2 (=voltage Vscn+voltage Vr, in the embodiment), and applies the ramp voltage to scan electrodes SC1 through SCn. The ramp voltage keeps rising while input terminal IN1 is kept in ‘Hi’ or until reference potential A reaches voltage Vr.

In period T12, as described above, Miller integration circuit 53 generates ramp voltage L1 with a moderate increase from voltage Vi1 toward voltage Vi2 (that exceeds the discharge start voltage and equals to voltage Vs in the embodiment).

<period T13>

In period T13, input terminal IN1 is set in ‘Lo’ to stop Miller integration circuit 53. At the same time, switching elements QH1 through QHn are turned off, whereas switching elements QL1 through QLn are turned on. Reference potential A is applied to scan electrodes SC1 through SCn. Besides, the clamp circuit of sustain pulse driver generation circuit 50 clamps reference potential A to voltage Vs, by which the voltage applied to scan electrodes SC1 through SCn decreases to voltage Vi3 (=voltage Vs, in the embodiment).

<period T14>

In period T14, input terminal IN4 is set in ‘Hi’ so as to turn on switching element Q21. The switching control above allows resistors 12 and 13 to be electrically connected in parallel. At the same time, input terminal IN2 is set in ‘Hi’, by which constant current generation circuit 61 starts operation. The constant current fed from constant current generation circuit 61 in the period has a current value greater than that fed in period T1. The constant current fed from constant current generation circuit 61 flows toward capacitor C2. The drain voltage of switching element Q2 goes down, with a ramp waveform, toward negative voltage Vi4 (=voltage Va, in the embodiment). Similarly, the output voltage of scan electrode driver circuit 43 goes down, with a ramp waveform having a gradient steeper than that of erasing down-ramp voltage L5, toward negative voltage Vi4. The combined resistance value of resistor R12 and resistor 13 is determined in advance so that the gradient of the ramp waveform voltage has an intended value (for example, −2.5V/μsec).

The ramp voltage keeps falling while input terminal IN2 is kept in ‘Hi’ or until reference potential A reaches voltage Va. In the embodiment, when the output voltage of scan electrode driver circuit 43 reaches negative voltage Vi4 (voltage Va, in the embodiment), input terminal IN2 is set in ‘Lo’. Ramp voltage L2 is thus generated and applied to scan electrodes SC1 through SCn.

As described above, scan electrode driver circuit 43 generates erasing down-ramp voltage L5 as the second down-ramp waveform voltage, erasing up-ramp voltage L3, ramp voltage L1, and ramp voltage L2 (ramp voltage L4) as the first down-ramp waveform voltage.

According to the structure shown in FIG. 12, ramp voltage L2 and erasing down-ramp voltage L5 are decreased to voltage Va, but it is not limited thereto. For example, the decrease may be stopped at a voltage obtained by adding predetermined positive voltage Vset2 onto voltage Va. According to the structure shown in FIG. 12, ramp voltage L2 and erasing down-ramp voltage L5 increase at once when reaching a predetermined low value, but it is not limited thereto. For example, when ramp voltage L2 and erasing down-ramp voltage L5 reach a predetermined low value, they may be maintained at the value for a period.

According to the embodiment, as described above, when the number of the sustain pulses generated in the subfield immediately before the current subfield is not greater than a predetermined threshold, the current subfield has time width T for erasing up-ramp voltage L3 longer than that of other subfields. The structure above allows an address discharge to generate with stability, even if the aforementioned non-lighting generation pattern occurs in displaying image on panel 10.

Although erasing down-ramp voltage L5 is applied to scan electrodes SC1 through SCn in all the subfields in the embodiment, it is not limited thereto. For example, erasing down-ramp voltage L5 may be generated only in a subfield with a luminance weight of large value (where accumulation of unnecessary wall charge easily occurs). Suppose that, for example, one field is divided into eight subfields from SF1 to SF8 and each of the subfields has luminance weight of 1, 2, 4, 8, 16, 32, 64, and 128. In that case, erasing down-ramp voltage L5 may be generated only in SF6 through SF8 that have relatively large luminance weight. The structure above is also effective in generating address discharge with stability.

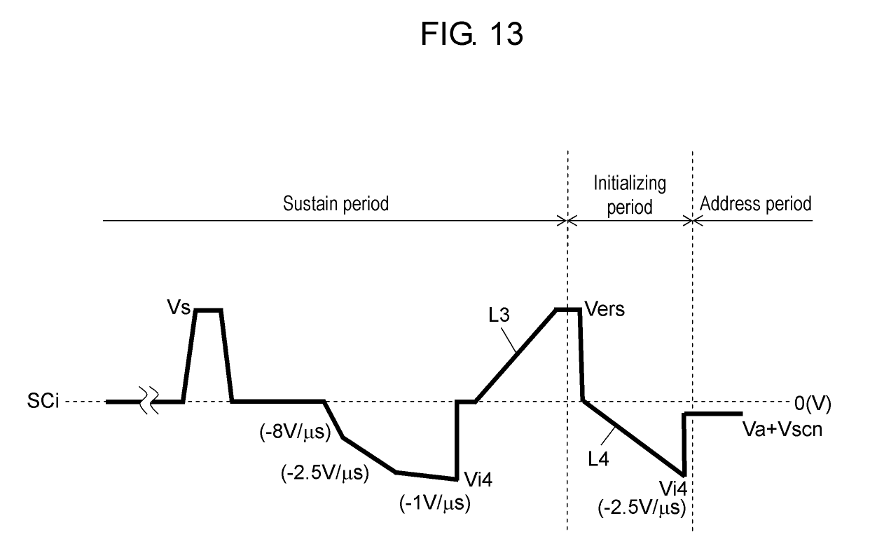

In the structure of the embodiment, erasing down-ramp voltage L5 is generated with a fixed gradient, but it is not limited thereto. As another possible structure, the application period of erasing down-ramp voltage L5 may be divided into sub-periods each of which having a different gradient of the voltage. FIG. 13 shows another waveform of erasing down-ramp voltage L5 to be applied to scan electrodes 22 in accordance with the exemplary embodiment.

In the structure employing the waveform shown in FIG. 13, first, erasing down-ramp voltage L5 decreases with a gradient (e.g. −8V/μsec) steeper than that of ramp voltage L2 until generation of erasing discharge; next, it decreases with a gradient (e.g. −2.5V/μsec) similar to that of ramp voltage L2; and lastly, it decreases with a gradient (e.g. −1V/μsec) gentler than that of ramp voltage L2. The inventor has found that the structure above is also effective in generating address discharge with stability. As another advantage, the structure shortens the period for generating the erasing down-ramp voltage.

As described above, when the number of the sustain pulses generated in the subfield immediately before the current subfield is not greater than a predetermined threshold, the current subfield has time width T for erasing up-ramp voltage L3 longer than that of other subfields. Preferably, the extended period of time width T should be properly determined so that the amplitude of the address pulses necessary for generating a stable address discharge is kept not greater than that in other subfields.

Each control signal described in the embodiment does not necessarily have the polarity described in the embodiments; a control signal having opposite polarity can be employed, as long as it works similar to that in the structure described in the embodiment.

Each circuit block shown in the exemplary embodiment of the present invention may be formed as an electric circuit that performs each operation shown in the exemplary embodiment, or formed of a microcomputer programmed so as to perform the similar operation, for example.

In the example described in the exemplary embodiment, one pixel is formed of discharge cells of three colors of R, G, and B. Also a panel having discharge cells that form a pixel of four or more colors can use the configuration shown in this exemplary embodiment and provide the same advantage.

The aforementioned driver circuit is only shown as an example in the exemplary embodiment of the present invention. The present invention is not limited to the structure of the driver circuit.

The specific numerical values shown in the exemplary embodiment of the present invention are set based on the characteristics of panel 10 that has a 50-inch screen and 768 display electrode pairs 24, and simply show examples in the exemplary embodiment. The present invention is not limited to these numerical values. Preferably, each numerical value should be set optimally for the characteristics of the panel, the specifications of the plasma display apparatus, or the like. Variations are allowed for each numerical value within the range in which the above advantages can be obtained. Further, the number of subfields, the luminance weights of the respective subfields, or the like is not limited to the values shown in the exemplary embodiment of the present invention. The subfield structure may be switched based on image signals, for example.

### INDUSTRIAL APPLICABILITY

The present invention allows a panel—even having a high-definition large-sized screen—to generate address discharge with stability, with power consumption suppressed. Thus, the present invention is useful in providing a method of driving a panel and a plasma display apparatus.

### REFERENCE MARKS IN THE DRAWINGS

10 panel
21 front substrate
22 scan electrode
23 sustain electrode
24 display electrode pair
25, 33 dielectric layer
26 protective layer
30 plasma display apparatus
31 rear substrate
32 data electrode
34 barrier rib
35 phosphor layer
36 image signal processing circuit
42 data electrode driver circuit
43 scan electrode driver circuit
44 sustain electrode driver circuit
45 control signal generation circuit
50 sustain pulse generation circuit
51 initializing waveform generation circuit
52 scan pulse generation circuit
53, 54, 55 Miller integration circuit
61 constant current generation circuit
Q1, Q2, Q3, Q4, Q5, Q6, Q21, QH1-QHn, QL1-QLn, switching element
C1, C2, C3, C31 capacitor
Di31 diode
Di9, Di10 zener diode
R1, R2, R3, R9, R12, R13 resistor
Q9 transistor
L1 ramp voltage
L2, L4 ramp voltage
L3 erasing up-ramp voltage
L5 erasing down-ramp voltage

1. A method of driving a plasma display panel having a plurality of discharge cells, each of the discharge cells including a data electrode and a display electrode pair formed of a scan electrode and a sustain electrode,
wherein one field period is formed by a plurality of subfields, each of the subfields having:
an address period; and
a sustain period for applying sustain pulses corresponding in number to luminance weight to the display electrode pairs,
the method comprising:
applying an up-ramp waveform voltage to the scan electrode at an end of the sustain period, wherein the up-ramp voltage increases from a base potential toward a predetermined voltage, after reaching the predetermined voltage, the up-ramp voltage is maintained at the voltage for a predetermined period of time, and then the up-ramp voltage decreases to the base potential; and
determining that, when the number of the sustain pulses is not greater than a predetermined threshold in a subfield, setting the predetermined period of time of a subfield immediately after the subfield to be longer than the predetermined period of time of other subfields.

2. The method of driving a plasma display panel of claim 1, wherein after generation of the sustain pulses in the sustain period, a down-ramp waveform voltage that falls toward a negative voltage exceeding a discharge start voltage is applied to the scan electrode, and thereafter, the up-ramp waveform voltage is applied to the scan electrode.

3. A plasma display apparatus comprising:
a plasma display panel having a plurality of discharge cells, each of the discharge cells including a data electrode and a display electrode pair formed of a scan electrode and a sustain electrode; and
a driver circuit for driving the panel,
wherein, one field period is formed by a plurality of subfields, each of the subfields having:
an address period; and
a sustain period for applying sustain pulses corresponding in number to luminance weight to the display electrode pair,
wherein, the driver circuit applies an up-ramp waveform voltage to the scan electrode in an end of the sustain period, wherein the up-ramp voltage increases from a base potential toward a predetermined voltage, after reaching the predetermined voltage, the up-ramp voltage is maintained at the voltage for a predetermined period of time, and the up-ramp voltage decreases to the base potential, and when the number of the sustain pulses is not greater than a predetermined threshold in a subfield, the driver circuit sets the predetermined period of time of a subfield immediately after the subfield to be longer than the predetermined period of time of other subfields.

4. The plasma display apparatus of claim 3, wherein after generation of the sustain pulses in the sustain period, the driver circuit applies a down-ramp waveform voltage, which falls toward a negative voltage exceeding a discharge start voltage, to the scan electrode, and thereafter, the driver circuit applies the up-ramp waveform voltage to the scan electrode.
